(19) United States
(12) Patent Application Publication
(10) Pub. No.: US 2020/0082703 A1
(43) Pub. Date: Mar. 12, 2020

(54) SENSOR ASSEMBLY FOR MEASURING VARIOUS MEASUREMENT VALUES OF MACHINE AND OPERATION DATA PROVIDING METHOD OF MACHINE COLLECTED FROM SENSOR ASSEMBLY

(71) Applicant: Jin Sik LEE, Hanam-si (KR)

(72) Inventor: Jin Sik LEE, Hanam-si (KR)

(21) Appl. No.: 16/680,946

(22) Filed: Nov. 12, 2019

Related U.S. Application Data
(63) Continuation of application No. PCT/KR2017/012142, filed on Oct. 31, 2017.

(30) Foreign Application Priority Data
Jun. 21, 2017 (KR) 10-2017-0078500
Jun. 21, 2017 (KR) 10-2017-0078501

(51) Int. Cl. G08B 21/18; G01M 13/00

(52) U.S. Cl. CPC G08B 21/182; G01M 13/00

(57) ABSTRACT

A sensor device for measuring operation data of a machine according to an embodiment of the present invention includes a substrate in which a sensor for measuring specific operation data of the machine is mounted; a housing having an opening formed at an upper portion such that the substrate is inserted and a pair of substrate guide members formed at an inner side surface so as to guide an insertion direction of the substrate; a housing cover that covers the opening; a filler which is injected into the housing so as to fix the substrate inserted into the housing and is cured; and an insert nut in which a raised press-fitting member is formed in an outer circumferential surface and a screw thread is formed in an inner circumferential surface.

### CROSS-REFERENCE TO RELATED APPLICATIONS

This application is a continuation of International Application No. PCT/KR2017/012142 filed on Oct. 31, 2017 which claims priority to Korean Patent Application No. 10-2017-0078500 and No. 10-2017-0078501 filed on Jun. 21, 2017, the entire contents of which are herein incorporated by reference.

### TECHNICAL FIELD

The present invention relates to a sensor assembly for measuring various measurement values of a machine and a method of providing operation data of a machine collected from the sensor assembly.

### BACKGROUND ART

A machine information recognition sensor installed in an in-plant motor, fan equipment, or an in-tunnel jet fan which are known has been supplied at a very high price. One way to confirm an abnormal state of the motor or the fan is to confirm whether or not there is abnormality in an RPM value of the motor. By checking a vibration value of the motor or the fan, it is possible to confirm RPM.

A vibration sensor attached to the motor or the fan is very expensive. A price thereof is hundreds of thousands of won close to one hundred won. Accordingly, since a burden on purchasing is considerable, there was a limit to being widely utilized in various industrial sites.

Further, even if a vibration value is detected through the sensor attached to the motor or the fan, it is necessary to have a method of conveniently informing a user (for example, a plant manager) in real time by analyzing the vibration value. The related art has a problem in that a server collects data in real time from a large number of sensors and thereby a load of the server is enormous, or a wireless communication connection between the sensor and an AP module is not smooth at times.

### SUMMARY OF INVENTION

### Technical Problem

Accordingly, an object of the present invention is to provide a sensor (vibration, temperature, gyroscope) that is mounted in a small case to be fixed with an epoxy resin or the like and is easily attached to a motor or a fan.

Further, another object of the present invention is to provide efficiently an operation data by extracting an average value through a root mean square value of a value sensed on an AP module (or relay module) and to transmitting a purified value (average value) to a server.

### Solution to Problem

In order to achieve the above-described technical problems, a sensor device for measuring operation data of a machine according to an embodiment of the present invention includes a substrate in which a sensor for measuring specific operation data of the machine is mounted; a housing having an opening formed at an upper portion such that the substrate is inserted and a pair of substrate guide members formed at an inner side surface so as to guide an insertion direction of the substrate; a housing cover that covers the opening; a filler which is injected into the housing so as to fix the substrate inserted into the housing and is cured; and an insert nut in which a raised press-fitting member is formed in an outer circumferential surface and a screw thread is formed in an inner circumferential surface. The insert nut is press-fitted into the outer lower surface of the housing and has a space formed for insertion of a bolt protruding from a partial surface of the machine.

Further, a method of providing operation data collected from a sensor assembly according to an embodiment of the present invention includes (a) step of acquiring second operation data obtained by resampling first operation data measured by a sensor assembly, from the first user terminal; (b) step of determining whether or not the second operation data exceeds a threshold; and (c) step of providing an alarm to a second user terminal in a case where the second operation data exceeds the threshold, which are performed by a server.

Further, a method of providing operation data collected from a sensor assembly according to an embodiment of the present invention includes (a) step of acquiring first operation data measured in real time at a first sampling rate for an operation of a machine, from the sensor assembly; (b) step of acquiring second operation data by resampling the first operation data in real time at a second sampling rate lower than the first sampling rate; and (c) step of providing the second operation data to a server, which are performed by a user terminal connected to the sensor assembly, and in the step (b), the second operation data may be acquired by calculating a root mean square value or a frequency value for the first operation data, based on the time interval for each time interval corresponding to the second sampling rate.

Further, a method of providing operation data collected from a sensor assembly according to an embodiment of the present invention includes (a) step of acquiring first period operation data corresponding to an event occurrence period of operation data measured by a sensor assembly from a server; (b) step of acquiring second period operation data obtained by resampling data corresponding a remaining period of the event occurrence period of the operation data at a sampling rate lower than a sampling rate of the first period operation data, from the server; and (c) step of subsequently displaying the first period operation data and the second period operation data in order of measurement times such that time axis intervals between data samples are equal to each other, which are performed b a user terminal providing the operation data to a user, and in the step (b), the second operation data is acquired by calculating a root mean square value or a frequency value for the first operation data, based on the time interval for each time interval corresponding to the second sampling rate.

### Advantageous Effects of Invention

According to a sensor assembly of an embodiment of the present invention, an angle of a substrate inserted into a housing of each of a plurality of sensor assemblies is constant, and thus, it is possible to provide a sensor assembly with a less deviation in vibration module measurement values of the plurality of sensor assemblies.

According to the sensor assembly of the embodiment of the present invention, the sensor assembly can be directly attached to a machine by using a spanner, and thus, it is possible to provide a sensor assembly that can be easily installed.

According to the sensor assembly of an embodiment of the present invention, the sensor assembly can be manufactured through the small number of processes, it is possible to provide a sensor assembly capable of low-cost production.

According to an operation data providing method of an embodiment of the present invention, each of user terminals collecting collection operation data from a plurality of machines resamples the data to an average value, and thus, it is possible to reduce the amount of data communication required between the user terminals collecting the operation data and the server.

According to the operation data providing method of the embodiment of the present invention, data of a time zone in which an event does not occur for the machine has a timelapse effect, and thus, it is possible to increase identification of the data in the time zone in which the event occurs.

According to the operation data providing method of the embodiment of the present invention, in a case where an event occurs in any one of the machines while the data of the plurality of machines has the timelapse effect, data of all the machines in the time zone in which the event occurs is displayed on the same time axis, and thus, it is possible to easily compare a machine in which the event occurs with the rest of machines.

### BRIEF DESCRIPTION OF DRAWINGS

FIG. 1 is a schematic exploded perspective view illustrating a configuration of a sensor assembly according to an embodiment of the present invention.

FIG. 2 is a longitudinal cross-sectional view of the sensor assembly according to the embodiment of the present invention.

FIG. 3 is a top and bottom view of a housing according to the embodiment of the present invention.

FIG. 4A is schematic views illustrating a method of manufacturing the sensor assembly according to the embodiment of the present invention.

FIG. 4B is schematic views illustrating a method of manufacturing the sensor assembly according to the embodiment of the present invention.

FIG. 4C is schematic views illustrating a method of manufacturing the sensor assembly according to the embodiment of the present invention.

FIG. 4D is schematic views illustrating a method of manufacturing the sensor assembly according to the embodiment of the present invention.

FIG. 4E is schematic views illustrating a method of manufacturing the sensor assembly according to the embodiment of the present invention.

FIG. 5 is a schematic perspective view illustrating a manufactured state of the sensor assembly according to the embodiment of the present invention.

FIG. 6 is a schematic perspective view illustrating a manufactured state of a sensor assembly according to another embodiment of the present invention.

FIG. 7 is a partial longitudinal cross-sectional view illustrating a structure of an insert nut according to the embodiment of the present invention.

FIG. 8 is a diagram illustrating a configuration of an operation data providing system according to the embodiment of the present invention.

FIG. 9 is a diagram illustrating a configuration of a server according to the embodiment of the present invention.

FIG. 10 is an operation flowchart illustrating an operation data providing method performed by the server according to the embodiment of the present invention.

FIG. 11 is an operation flowchart illustrating an operation data providing method performed by a server according to another embodiment of the present invention.

FIG. 12 is a diagram illustrating an example of providing operation data according to the present invention.

FIG. 13 is a diagram illustrating an example of providing a plurality of pieces of operation data according to the present invention.

### DETAILED DESCRIPTION

Hereinafter, embodiments of the present invention will be described in detail with reference to the accompanying drawings such that those skilled in the art can easily implement the present invention. The invention can be embodied in many different forms and is not limited to the embodiments described herein. Further, portions not related to the description are omitted in the drawings so as to describe the present invention more clearly, and like reference numerals are attached to like portions throughout the specification.

Throughout the specification, when a part is referred to as being “connected” to another part, this includes not only “directly connected” but also “electrically connected” with another element therebetween. Further, when a part is referred to as “including” a configuration element, it means that the configuration element does not exclude other configuration elements but may further include other configuration elements unless describes otherwise in particular, and it is to be understood that the configuration element does not preclude presence or addition of one or more other features, numerals, steps, operations, configuration elements, components, or a combination thereof.

The following embodiments are detailed description to aid in understanding the present invention, and do not limit the scope of the present invention. Therefore, an invention of the same scope for performing the same function as the present invention will also fall within the scope of the present invention.

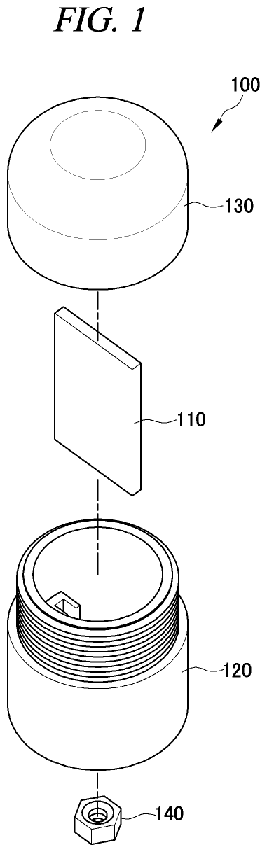

FIG. 1 is a schematic exploded perspective view illustrating a configuration of a sensor assembly 100 according to an embodiment of the present invention.

Referring to FIG. 1, the sensor assembly 100 according to the embodiment of the present invention includes a substrate 110, a housing 120, a housing cover 130, and an insert nut 140.

A processor chip and a sensor for measuring specific operation data of a machine may be mounted on the substrate 110.

Here, the machine may be a typical in-plant motor, a fan equipment, or a jet fan in a tunnel.

Here, the sensor can include a vibration sensing module for measuring a vibration of the machine, a temperature sensing module for measuring a temperature of the machine, and a gyroscope module for measuring a tilt of the machine.

In an optional embodiment, the sensor can further include a microphone module for measuring a vibration of a second frequency bandwidth different from a first frequency bandwidth measured by a vibration sensing module described above.

For example, the microphone module may be for measuring a vibration of a higher frequency bandwidth than a frequency bandwidth of the above-described vibration sensing module.

The housing 120 is a substrate case, has an inner space for containing the substrate 110, and has an opening into which the substrate 110 can be inserted. After the substrate 110 is inserted into the housing 120, the opening can be covered by the housing cover 130.

The insert nut 140 is a member for fixing the housing 120 to the machine, is press-fitted into a lower surface of the housing 120 to be fastened to a bolt protruding from a partial surface of the machine, and thereby, the housing 120 can be fixed to the machine.

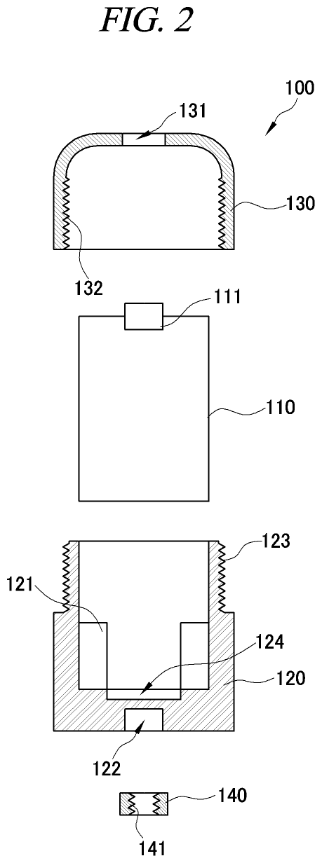

FIG. 2 is a longitudinal cross-sectional view of the sensor assembly 100 according to the embodiment of the present invention.

Referring to FIG. 2, the sensor assembly 100 includes the substrate 110, the housing 120, the housing cover 130, and the insert nut 140.

A sensor that measures specific operation data of the machine and a terminal 111 to which a cable for transmitting the operation data measured by the sensor to the outside can be connected may be further mounted on the substrate 110.

The operation data measured by the sensor can be transmitted to the operation data collection device through the cable connected to the terminal 111.

The operation data collection device can receive the operation data from a plurality of sensor assemblies 100 and stores the operation data.

The housing 120 can have an inner space for containing the substrate 110 and an opening through which the substrate 110 is inserted into an upper portion of the housing 120.

A pair of substrate guide members 121 for guiding an insertion direction of the substrate 110 can be formed on an inner side surface of the housing 120. In this case, the substrate guide member 121 may have a shape for inserting the substrate 110 in a direction perpendicular to a bottom surface of the housing 120. Accordingly, the substrate 110 can be inserted in a direction perpendicular to the bottom surface of the housing 120 by the substrate guide member 121.

A screw thread 123 can be formed on an outer circumferential surface of the opening formed in the upper portion of the housing 120 such that the housing cover 130 can be coupled thereto. At this time, a screw thread 132 is formed in the inner circumferential surface of the housing cover 130 to screw to the screw thread 123, and thereby, the housing cover 130 can be screwed to the upper portion of the housing 120. Accordingly, the opening formed in the housing 120 can be covered by the housing cover 130.

When the opening of the housing 120 is covered by the housing cover 130, a through hole 131 can formed in one surface of the housing cover 130 such that the cable connected to the terminal 111 is exposed to the outside of the housing 120.

In an optional embodiment, the terminal 111 can be disposed to protrude sufficiently from the substrate 110 so as to protrude out of the housing 120 through the through hole 131. In this case, a cable for transmitting the operation data to the outside may be connected to the terminal 111 protruding outside the housing 120.

As an embodiment of a coupling member of the housing 120 and the machine, a magnet that magnetically couples with a partial surface of a machine can be installed in the inner space of the housing 120. At this time, a magnet guide groove 124 for guiding an installation position of the magnet can be formed in an inner bottom surface of the housing 120. Accordingly, the magnet can be installed so as to fit the magnet guide groove 124, and the bottom surface of the housing 120 can be fixed to the partial surface of the machine by the magnet.

In another embodiment of the coupling member of the housing 120 and the machine, an insert nut 140 can be press-fitted into an outer lower surface of the housing 120 for being screwed to a bolt protruding from a partial surface of the machine.

At this time, a recessed groove 122 for guiding a press-fitting direction of the insert nut 140 can be formed in an outer bottom surface of the housing 120, and a raised press-fitting member for being press-fitted into the recessed groove 122 can be formed in an outer circumferential surface of the insert nut 140.

Here, the raised press-fitting member is a member having an outer diameter larger than an inner diameter of the recessed groove 122, and when the raised press-fitting member is press-fitted into the recessed groove 122, at least one of the raised press-fitting member and the recessed groove 122 is changed in shape, and thereby, the press-fitting can made.

A screw thread 141 which is screwed to a bolt protruding from a partial surface of the machine can be formed in an inner circumferential surface of the insert nut 140. Accordingly, the insert nut 140 can be press-fitted into the recessed groove 122, and the outer lower surface of the housing 120 can be fixed to the partial surface of the machine by the insert nut 140.

As such, the sensor assembly 100 according to the embodiment of the present invention can employ at least one member of the magnet and the insert nut 140 which are described above as the coupling member of the housing 120 and the machine.

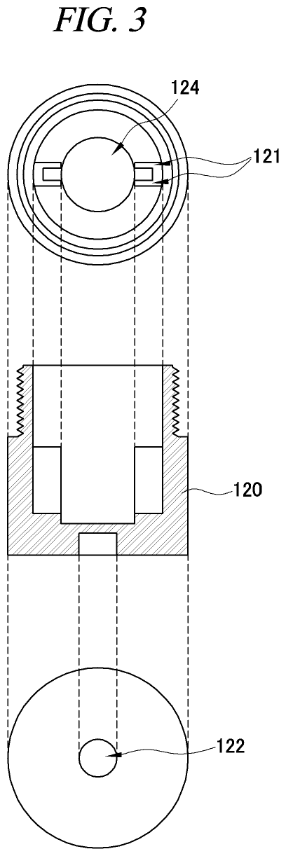

FIG. 3 is a top and bottom view of the housing 120 according to the embodiment of the present invention.

Particularly, FIG. 3 is a top view, which is viewed from above, of the housing 120 according to an embodiment of the present invention, and is a bottom view viewed from below.

Referring to the top view of FIG. 3, the housing 120 according to the embodiment of the present invention can include the substrate guide member 121 and the magnet guide groove 124 in the inner space thereof.

The sensor assembly according to the embodiment of the present invention is characterized in being attached to each of a plurality of machines to measure operation data of each of the machines.

At this time, if angles of the substrates of the sensor assemblies attached to each of the plurality of machines are different from each other, a deviation between vibration module measurement values of the substrates can occur.

In order to reduce the deviation, the substrate guide member 121 can have a shape for inserting the substrate in a direction perpendicular to the bottom surface of the housing 120.

At this time, the substrate guide member 121 can have a groove, which is equal to a thickness of the substrate, formed therein such that an angle formed between the substrate and the bottom surface of the housing 120 can be maintained vertically.

For example, the substrate guide member 121 can have a groove equal to the thickness of the substrate.

Further, the sensor assembly according to the embodiment of the present invention can include a magnet as a coupling member with the machine.

To this end, the magnet guide groove 124 for guiding an installation position of the magnet can be formed in the housing 120. At this time, the magnet guide groove 124 can be formed in the center of the inner bottom surface of the housing 120 and can have a shape corresponding to a shape of the magnet to be installed.

Further, the sensor assembly according to the embodiment of the present invention can include an insert nut as a coupling member with a machine.

Referring to the bottom view of FIG. 3, the recessed groove 122 can be formed in the center of the outer lower surface the housing 120 according to the embodiment of the present invention, the insert nut can be press-fitted into the recessed groove 122.

Although not illustrated in FIG. 3, a guide portion (not illustrated) of a through-hole shape can be formed in the center of the outer lower surface of the housing 120 according to the embodiment of the present invention, and the insert nut can be press-fitted into the guide portion.

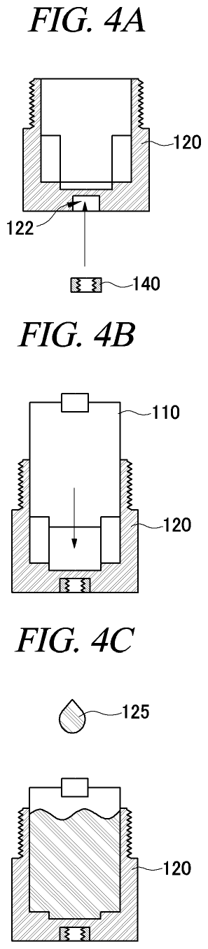

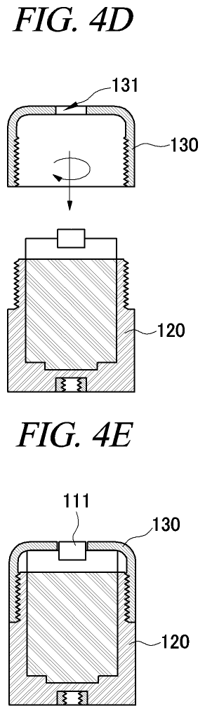

FIG. 4A to FIG. 4E are schematic views illustrating a method of manufacturing the sensor assembly according to the embodiment of the present invention.

Referring to FIG. 4A to FIG. 4E, in the method of manufacturing the sensor assembly according to the embodiment, the insert nut 140 is first press-fitted into the recessed groove 122 formed in the outer lower surface of the housing 120.

Next, the substrate 110 is inserted through the opening of the housing 120.

At this time, the substrate 110 can be inserted in a direction perpendicular to the inner bottom surface of the housing 120 so as to fit a substrate guide member formed in the inner space of the housing 120.

In an optional embodiment, the magnet can be installed so as to fit the magnet guide groove formed in the inner bottom surface of the housing before inserting the substrate 110 into the housing 120.

Next, in order to fix the substrate 110 to the housing 120, a filler 125 is injected through the opening and then cured.

Here, the filler 125 can include a curable resin (for example, a thermosetting resin such as an epoxy resin, or the like), but the present invention is not limited to this.

Finally, the housing cover 130 covers the opening of the housing 120.

At this time, corresponding screw threads are formed in a lower inner circumferential surface of the housing cover 130 and an upper outer circumferential surface of the housing 120, and thereby, the housing cover 130 and the housing 120 can be screwed together.

When the housing cover 130 covers the opening, the terminal 111 mounted on the substrate 110 can protrude to the outside through the through hole 131 formed in the housing cover.

In an optional embodiment, in a case where the terminal 111 mounted on the substrate 110 does not protrude sufficiently, the terminal 111 may not protrude to the outside through the through hole 131. In this case, the cable can be first connected to the terminal 111 through the through hole 131, and then the housing cover 130 can cover the opening.

Although not illustrated in FIG. 4A to FIG. 4E, the manufactured sensor assembly can be attached to a machine by screwing the press-fitted insert nut 140 to a bolt protruding from a partial surface of the machine.

As described above, the sensor assembly according to the embodiment of the present invention can be manufactured only through the small number of processes, and thus, there is an effect that costs are reduced more than using a known vibration sensor.

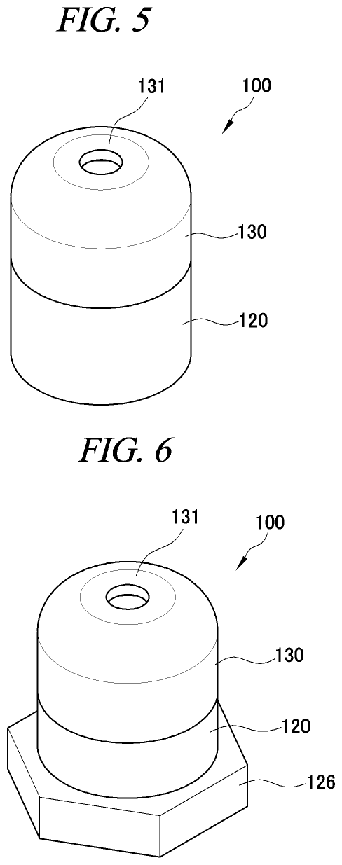

FIG. 5 is a schematic perspective view illustrating a manufactured state of the sensor assembly 100 according to the embodiment of the present invention.

Referring to FIG. 5, the sensor assembly 100 according to the embodiment of the present invention includes the housing 120 having a substrate fixed therein, the housing cover 130 covering an opening of the housing, and the through hole 131 for a cable to be connected to the substrate to pass through.

At this time, a terminal mounted on the substrate can be directly exposed, or the cable connected to the terminal can be exposed through the through hole 131.

FIG. 6 is a schematic perspective view illustrating a manufactured state of the sensor assembly 100 according to another embodiment of the present invention.

Referring to FIG. 6, the sensor assembly 100 according to another embodiment of the present invention can have a lower side surface 126 of the housing 120 having a protruded hexagonal shape.

Accordingly, in screwing the insert nut press-fitted into the housing 120 to a bolt protruding from a partial surface of a machine, the housing 120 can be easily rotated by using a spanner.

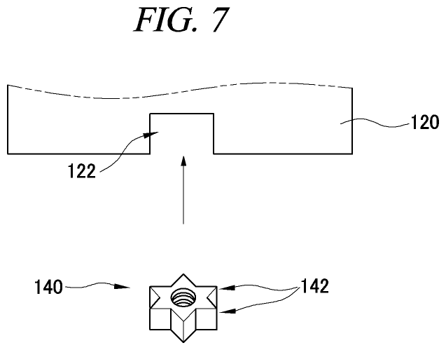

FIG. 7 is a partial longitudinal cross-sectional view illustrating a structure of the insert nut 140 according to the embodiment of the present invention.

Referring to FIG. 7, the insert nut 140 according to the embodiment of the present invention is a raised press-fitting member and has a plurality of teeth 142 formed in an outer circumferential surface of the insert nut 140.

In this case, when the raised press-fitting member is press-fitted into the recessed groove 122, the recessed groove 122 can be press-fitted while being recessed in the form of a tooth 142.

The number of teeth 142 can be five or six, but the present invention is not limited to this.

The sensor assembly according to the embodiment of the present invention is coupled to a machine by rotating the housing 120 when being fixed to the machine by using the insert nut 140, and can have a stronger holding force against the rotation through the raised press-fitting member described above.

In the following description, the server 1100 can mean an operation data providing server, a first user terminal 1210 can mean a user terminal connected to the sensor assembly 1220, and the second user terminal 1240 can mean a user terminal that provides operation data to a user.

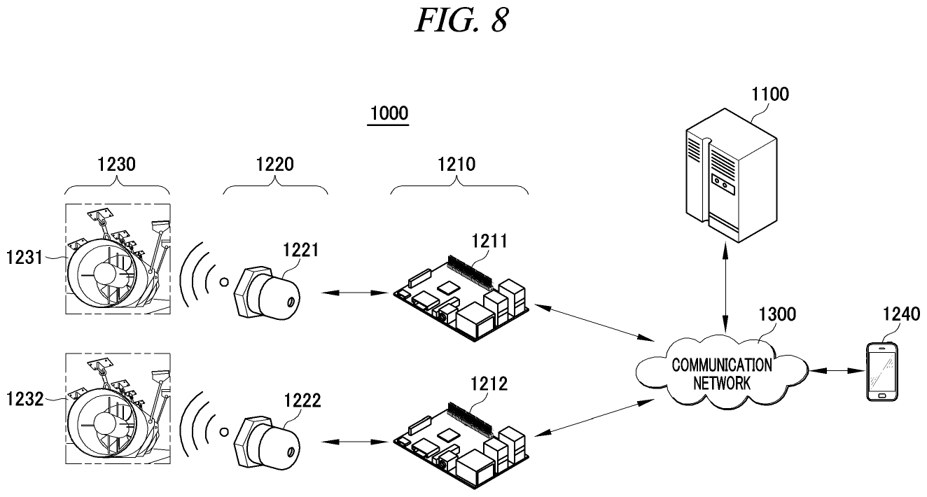

FIG. 8 is a diagram illustrating a configuration of an operation data providing system 1000 according to the embodiment of the present invention.

Referring to FIG. 8, an operation data providing system 1000 according to the embodiment of the present invention includes a server 1100, user terminals 1210 and 1240, sensor assemblies 1220, and machines 1230. Further, a communication network 1300 for interconnecting the server 1100 with the user terminals 1210 and 1240 is included.

The server 1100 according to the embodiment of the present invention receives and processes operation data of the machine 1230 obtained by the sensor assembly 1220 from the first user terminal 1210 and transmits the processed data to the second user terminal 1240. The second user terminal 1240 is characterized in displaying the operation data provided from the server 1100 to a user.

Here, the operation data can be data including at least one of a vibration, a temperature, and a tilt of the machine.

The first user terminal 1210 can resample the operation data acquired from the sensor assembly 1220 and then transmit the resampled operation data to the server 1100.

Here, the first user terminal 1210 can resample the operation data sensed at a first sampling rate by the sensor assembly 1220 at a second sampling rate different from the first sampling rate.

In this case, the second sampling rate can be a sampling rate lower than the first sampling rate.

For example, the first sampling rate can be 2 kHz and the second sampling rate can be 20 Hz, but the present invention is not limited thereto.

Here, the first user terminal 1210 can acquire the resampled operation data through a process of taking a root mean square (RMS) value calculated based on a time interval for the operation data or an FFT analysis-based frequency value as a sample for each time interval corresponding to the second sampling rate.

For example, in a case where the second sampling rate is 20 Hz, the first user terminal 1210 acquire the resampled operation data by taking the root mean square value calculated for a period of 1/20 second as a sample, for every 1/20 second corresponding thereto.

As such, according to the embodiment of the present invention, each of the user terminals collecting the operation data from the plurality of machines resamples data to an average value and transmits the data to the server, and thereby, it is possible to reduce the amount of required data communication between the user terminals collecting the operation data and the server.

The server 1100 can determine whether or not a specific data sample exceeds a threshold for the resampled operation data received from the first user terminal 1210, and then alarm the second user terminal 1240 according to the determination result.

Further, the server 1100 can provide the resampled operation data received from the first user terminal 1210 to the second user terminal 1240 or can provide the operation data resampled once again for the resampled (for example, secondly resampled) operation data to the second user terminal 1240.

Here, the server 1100 can divide the period for the resampled operation data according to the determination of whether the specific data sample exceeds the threshold, and can provide the primarily resampled operation data to the second user terminal 1240 for the specific period and provide the secondarily resampled operation data to the second user terminal 1240 for the remaining period.

For example, when the specific data sample exceeds the threshold, the server 1100 can provide the second user terminal 1240 with the primarily resampled operation data for a period including the corresponding data sample and provide the second user terminal 1240 with the secondarily resampled operation data for the period not including the corresponding data sample.

At this time, the secondary resampling can be resampling at a third sampling rate lower than the second sampling rate.

For example, the second sampling rate can be 20 Hz and the third sampling rate can be 4 Hz, but the present invention is not limited thereto.

The second user terminal 1240 can receive an alarm from the server 1100 and display the corresponding alarm to a user.

Further, the second user terminal 1240 can receive the resampled operation data from the server 1100 and display the corresponding data to the user.

Here, the second user terminal 1240 can display the resampled operation data received from the server 1100 to the user in the form of a real time graph.

Meanwhile, as described above, in a case where the resampled operation data is received from the server 1100 at different sampling rates, the second user terminal 1240 can adjust a result graph to be displayed such that the time axis intervals between data samples included in the corresponding data are equal to each other.

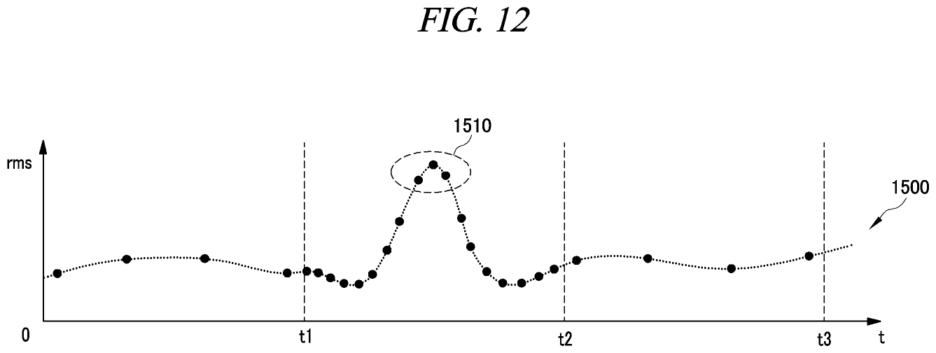

A more detailed description on the secondary resampling of the server 1100 and an adjustment of the result graph of the second user terminal 1240 will be described below with reference to FIG. 12.

The sensor assembly 1220 can sense operation data of the machine 1230 in real time.

The sensor assembly 1220 senses the operation data at the first sampling rate, where the first sampling rate can be a preset value for each sensing module.

Here, the sensing module can include a vibration sensing module for measuring a vibration of the machine, a temperature sensing module for measuring a temperature of the machine, and a gyroscope module for measuring a tilt of the machine.

The machine 1230 can be a known in-plant motor, fan equipment, or a jet fan in a tunnel.

Meanwhile, the operation data providing system according to the embodiment of the present invention can be a system for providing operation data of a plurality of machines 1231 and 1232.

In this case, the sensor assemblies 1221 and 1222 are installed in the machines 1231 and 1232 respectively to sense operation data, and the first user terminals 1211 and 1212 are connected to the sensor assemblies 1221 and 1222 respectively to acquire the operation data.

FIG. 8 illustrates that the sensor assembly 1221 and the first user terminal 1211 are configured in a one-to-one connection, but it is also possible to provide a many-to-one connection in which one first user terminal 1211 is connected to a plurality of sensor assemblies 1221 and 1222 to acquire a plurality of pieces of operation data.

The user terminals 1210 and 1240 mean communication terminals capable of transmitting and receiving data in a wired and wireless communication environment. Here, the first user terminal 1210 can be a micro computing device equipped with a micro controller unit (MCU) for resampling data. Further, the second user terminal 1240 can be a portable terminal of a user.

FIG. 8 illustrate that the first user terminal 1210 is a single board computer which is a kind of ultra-compact computing device and the second user terminal 1240 is a smart phone which is a kind of portable terminal, but the idea of the present invention is not limited to this and can be used for a terminal capable of transmitting and receiving data without limitation as described above.

Particularly, the second user terminal 1240 can include a handheld computing device (for example, PDA, email client, or the like), any form of cellular phone, or any form of other type of computing or communication platform but the present invention is not limited to this.

Meanwhile, the communication network 1300 serves to connect the server 1100 to the user terminals 1210 and 1240. That is, the communication network 1300 means a communication network that provides a connection path such that data is transmitted and received after the user terminals 1210 and 1240 are connected to the server 1100. The communication network 1300 can be a wired network such as LANs (Local Area Networks), WANs (Wide Area Networks), MANs (Metropolitan Area Networks), and ISDNs (Integrated Service Digital Networks), or a wireless network such as wireless LANs, CDMA, Bluetooth, and satellite communications, but the scope of the present invention is not limited to this.

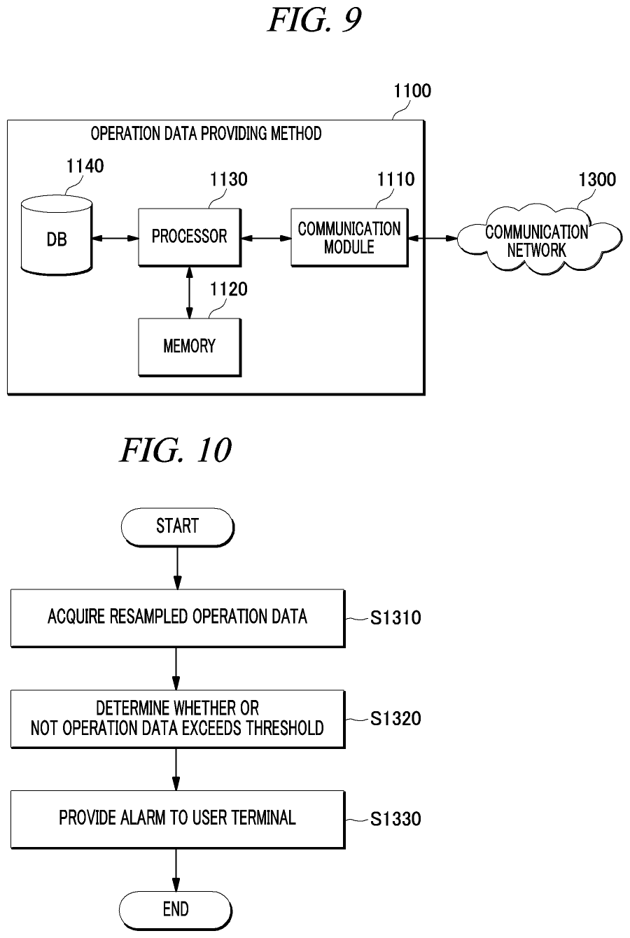

FIG. 9 is a diagram illustrating a configuration of the server 1100 according to the embodiment of the present invention.

Referring to FIG. 9, the server 1100 according to the embodiment of the present invention includes a communication module 1110, a memory 1120, a processor 1130, and a database 1140.

In detail, the communication module 1110 provides a communication interface necessary for providing transmission and reception signals between the server 1100 and the user terminals 1210 and 1240 in the form of packet data in cooperation with the communication network 1300.

Here, the communication module 1110 can be a device including hardware and software necessary for transmitting and receiving a signal such as a control signal or a data signal through a wired or wireless connection with another network device.

The memory 1120 stores a program for performing a method of providing a real estate enhancement service. Further, the memory functions to store temporarily or permanently data processed by the processor 1130. Here, the memory 1120 can include a magnetic storage media or a flash storage media, but the scope of the present invention is not limited to this.

The processor 1130 is a kind of central processing unit and controls the entire process of providing operation data. Each step performed by the processor 1130 will be described below with reference to FIG. 10.

Here, the processor 1130 can include all kinds of devices capable of processing data, such as a processor. Here, for example, the “processor” can mean a data processing device, which is embedded in hardware, having a circuit physically structured to perform a function represented as a code or a command included in a program. As such, an example of a data processing device embedded in the hardware can include a microprocessor, a central processing unit (CPU), a processor core, a multiprocessor, an ASIC (application-specific integrated device), an FPGA (field programmable gate array), and the like, but the scope of the present invention is not limited to this.

The database 1140 includes operation data acquired from the first user terminal 1210 and operation data resampled therefor.

Further, the database 1140 can further include information on an event occurrence time point and an event occurrence period for the operation data acquired from the first user terminal 1210.

Here, the event means factors that can affect an operation of the machine, such as a sudden change in sensing values such as a vibration, a temperature, and a tilt value, and exceeding a preset threshold range.

Although not illustrated in FIG. 9, a part of the above-described operation data, the resampled operation data, the event occurrence time point, and the event occurrence period can be stored in a database (not illustrated) that is physically or conceptually separated from the database 1140.

FIG. 10 is an operation flowchart illustrating an operation data providing method performed by the server 1100 according to an embodiment of the present invention.

Particularly, FIG. 10 is the operation flowchart illustrating the operation data providing method performed by the server 1100. Here, a program for performing each step of FIG. 10 is stored in the memory 1120, the corresponding program is executed by the processor 1130, and thereby, the operation data providing method can be performed.

Referring to FIG. 10, first, the server 1100 acquires resampled operation data from the first user terminal (S1310).

At this time, the resampled operation data can be data which is obtained by resampling the operation data acquired at the first sampling rate from the sensor assembly at the second sampling rate using the first user terminal and is transmitted.

Next, the server 1100 determines whether or not the resampled operation data exceeds a threshold (S1320).

As a result of the determination in step S1320, in a case where any data sample of the resampled operation data exceeds the threshold, the server 1100 provides an alarm to the second user terminal (S1330).

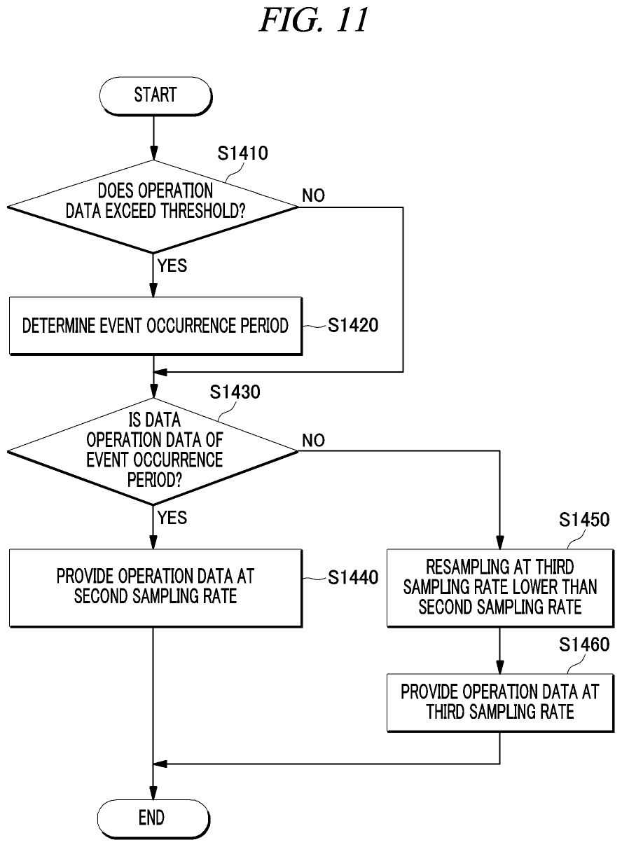

Although not illustrated in FIG. 10, in the operation data providing method performed by the server 1100 according to the embodiment of the present invention, the server 1100 can transmit the resampled operation data to the second user terminal after step S1220 (not illustrated). A more specific description relating to the step (not illustrated) in which the resampled operation data is transmitted to the second user terminal will be made below with reference to FIG. 11.

In the following, an additional embodiment of the present invention will be described.

FIG. 11 is an operation flowchart illustrating the operation data providing method performed by the server 1100 according to the embodiment of the present invention.

Particularly, FIG. 11 is an operation flowchart illustrating a process of determining an event occurrence period according to whether or not the operation data resampled (for example, primarily resampled) in step S1320 of FIG. 10 exceeds a threshold, and providing the primarily resampled operation or the secondarily resampled operation data for each period to the second user terminal.

Referring to FIG. 11, first, the server 1100 determines whether or not primarily resampled operation data exceeds a threshold (S1410).

As a result of the determination in step S1410, in a case where any data sample of the primarily resampled operation data exceeds the threshold, the server 1100 determines an event occurrence period based on a measurement time of the data sample exceeding the threshold (S1420).

In step S1420, the server 1100 can determine a time period between a start time obtained by subtracting a predetermined time from the measurement time of a data sample exceeding a threshold and an end time obtained by adding the predetermined time to the measurement time as an event occurrence period.

As an optional embodiment, in step S1420, in a case where any consecutive data samples exceed the threshold, the server 1100 can determine the event occurrence period based on a median value of the measurement time of the corresponding consecutive data samples.

Next, the server 1100 determines whether or not the primarily resampled operation data to be transmitted to the second user terminal 1210 is operation data of the event occurrence period (S1430).

in a case where the primarily resampled operation data is the operation data of the event occurrence period as a result of determination in step S1430, the existing operation data resampled (for example, primarily resampled) at the second sampling rate is provided to the second user terminal 1210 (S1440).

in a case where the primarily resampled operation data is not the operation data of the event occurrence period as the result of determination in step S1430, the primarily resampled operation data is resampled (for example, secondarily resampled) at a third sampling rate lower than the second sampling rate (S1460), and the secondarily resampled operation data is provided to the second user terminal 1240 (S1460).

FIG. 12 is a diagram illustrating an example of providing operation data 1500 according to the present invention.

Particularly, FIG. 12 is a diagram illustrating a secondary resampling of the server and a result graph adjustment process of the second user terminal.

Referring to FIG. 12, the operation data 1500 represents operation data obtained by secondary resampling operation data measured for one machine by using the server.

Here, an x axis of the graph means time when the server transmits data to the second user terminal, and a y axis thereof means a size of data value included in the data.

Here, the data value is a root mean square (rms) value or a frequency value, which is a value obtained by calculating (primarily resampled) the operation data measured for the machine by using the first user terminal as described above.

Points located on the operation data 1500 represent data samples transmitted from the server to the second user terminal, and the tighter the interval between the points, the higher the sampling rate.

The server can perform secondary resampling through the following processes.

First, the server receives the primarily resampled operation data from the first user terminal, and in a case where the corresponding data exceeds a threshold, the server can determine an event occurrence period t1-t2 including the period 1510 exceeding the threshold.

The server can determine a time period between a start time obtained by subtracting a predetermined time from a median time of the period 1510 exceeding the threshold and an end time obtained by adding the predetermined time to the median time as the event occurrence period t1-t2.

Next, the server can transmit the primarily resampled operation data corresponding to the event occurrence period t1-t2 to the second user terminal as it is, and can secondarily resample the primarily resampled operation data corresponding to remaining periods 0-t1 and t2-t3 of the event occurrence period and transmit secondarily resampled data to the second user terminal.

As illustrated in FIG. 12, it can be seen that the sampling rate of the secondarily resampled operation data in the remaining periods 0-t1 and t2-t3 is lower than the sampling rate of the primarily resampled operation data of the event occurrence period t1-t2.

Meanwhile, the second user terminal can adjust the result graph such that time axis intervals between the data samples become equal to each other for the received operation data 1500 and display the adjusted graph to a user.

In this case, the number of data samples in the remaining periods 0-t1 and t2-t3 is smaller than the number of data samples in the event occurrence period t1-t2, and thereby, a time axis interval is narrowed.

For example, in a case where a sampling rate of the remaining periods 0-t1 and t2-t3 is 4 Hz and a sampling rate of the event occurrence period t1-t2 is 20 Hz, the time axis interval of the remaining periods 0-t1 and t2-t3 can be narrower by five times (20 Hz/4 Hz) than the time axis interval of the event occurrence period t1-t2.

Accordingly, a user can feel as if time for data of a period in which an event does not occur advances rapidly.

As such, according to the embodiment of the present invention, data in a time zone in which the event does not occur for machines has the same effect as timelapse, and thereby, identification of data in a time zone in which an event occurs can be increased.

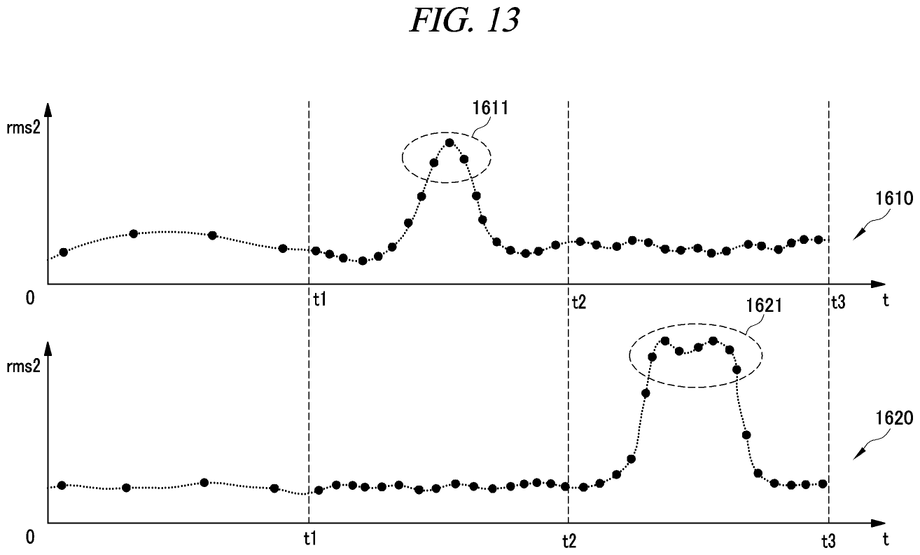

FIG. 13 is a diagram illustrating an example of providing a plurality of pieces of operation data 1610 and 1620 according to the present invention.

Referring to FIG. 13, the first operation data 1610 and the second operation data 1620 represent operation data obtained by secondarily resampling each of the operation data measured for different machines by using a server.

Here, the server can determine an event occurrence period for all the operation data, thereby, performing secondary resampling.

For example, the server can determine the event occurrence period t1-t2 so as to include a period 1611 exceeding the threshold in relation to the first operation data 1610 and determine the event occurrence period t2-t3 so as to include a period 1621 exceeding the threshold in relation to the second operation data 1620.

In this case, the server can determine the event occurrence period for each operation data, and then determine the corresponding event occurrence periods as the event occurrence periods t1-t2 and t2-t3 for all the operation data.

That is, the server can transmit all the primarily resampled operation data of the event occurrence periods t1-t2 and t2-t3 to the second user terminal as it is, and secondarily resample all the primarily resample operation data of a remaining period 0-t1 to transmit to the second user terminal.

As illustrated in FIG. 13, it can be seen that only the remaining period 0-t1 in which the event does not occur in common to the two pieces of operation data is secondarily resampled.

The second user terminal can display all the operation data 1610 and 1620 to a user in a graph along the same time axis.

That is, the second user terminal can adjust the result graph such that time axis intervals between the data samples become equal to each other for all the operation data 1610 and 1620 and display the adjusted graph to a user, and since the operation data 1610 and 1620 have the same sampling rate in a specific period, the adjusted graph can have the same time axis.

As such, according to the embodiment of the present invention, in a case where an event occurs in any one of the machines while the data of the plurality of machines has the timelapse effect, data of all the machines in the time zone in which the event occurs is displayed on the same time axis, and thus, it is possible to easily compare a machine in which the event occurs with the rest of machines.

The description of the present invention described above is for an illustrative purpose, and those skilled in the art to which the present invention belongs will be able to understand that the present invention can be changed to other specific forms without changing the technical idea or essential features of the present invention. Therefore, it should be understood that the embodiments described above are exemplary in all respects and not restrictive. For example, each configuration element described as a single type may be implemented in a distributed manner, and similarly, configuration elements described in a distributed manner may be implemented in a combined form.

It should be construed that the scope of the present invention is represented by the following claims rather than the detailed description, and all changes or modifications derived from the meaning and scope of the claims and their equivalents are included within the scope of the present invention.

The present invention relates to a construction of a sensor assembly for measuring various measurement values of a machine and to a method of providing operation data of the machine collected from the sensor assembly, thereby, having an industrial applicability.

What is claimed is:

1. A sensor device for measuring operation data of a machine comprising:
a substrate in which a sensor for measuring specific operation data of the machine is mounted;
a housing having an opening formed at an upper portion such that the substrate is inserted and a pair of substrate guide members formed at an inner side surface so as to guide an insertion direction of the substrate; and
a housing cover that covers the opening.

2. The sensor device according to claim 1, further comprising:
a filler which is injected into the housing so as to fix the substrate inserted into the housing and is cured.

3. The sensor device according to claim 1,
wherein a connection terminal is further mounted in one end of the substrate, and
wherein the housing cover has a through hole formed to expose a cable connected to the substrate or the connection terminal to the outside.

4. The sensor device according to claim 1, further comprising:
an insert nut in which a raised press-fitting member is formed in an outer circumferential surface and a screw thread is formed in an inner circumferential surface,
wherein a recessed groove or a hole-shaped guide portion for guiding an insertion direction of the insert nut is formed in an outer lower surface of the housing, and
wherein the insert nut is press-fitted into the outer lower surface and has a space formed for insertion of a bolt protruding from a partial surface of the machine.

5. The sensor device according to claim 4, wherein the insert nut has a plurality of teeth formed in the outer circumferential surface so as to be press-fitted into the guide portion and fixed to the guide portion.

6. The sensor device according to claim 4, wherein a cut surface of an outer side surface of the housing is formed in a hexagonal shape such that the housing easily rotates when the insert nut is screwed to the bolt.

7. The sensor device according to claim 1, further comprising:
a magnet which is installed in the housing and magnetically coupled to a partial surface of the machine,
wherein the housing has a magnet guide groove formed in an inner bottom surface of the housing so as to guide an installation position of the magnet.

8. The sensor device according to claim 1, wherein the sensor for measuring the specific operation data of the machine includes at least one of a vibration sensing module for measuring a vibration of the machine, a temperature sensing module for measuring a temperature of the machine, and a gyroscope module for measuring a tilt of the machine.

9. The sensor device according to claim 8, wherein the sensor for measuring the specific operation data of the machine further includes a microphone module for measuring a vibration of a second frequency bandwidth different from a first frequency bandwidth measured by the vibration sensing module.

10. The sensor device according to claim 1, wherein the housing and the housing cover have screw threads formed for screwing an upper outer circumferential surface of the housing to a lower inner circumferential surface of the housing cover.

11. An operation data providing method which is performed by a server, comprising:
(a) step of acquiring second operation data obtained by resampling first operation data measured by a sensor assembly, from a first user terminal;
(b) step of determining whether or not the second operation data exceeds a threshold; and
(c) step of providing an alarm to a second user terminal in a case where the second operation data exceeds the threshold.

12. The operation data providing method according to claim 11, wherein the second operation data is obtained by resampling the first operation data at a sampling rate lower than a sampling rate of the first operation data.

13. The operation data providing method according to claim 11, wherein the second operation data is a root mean square value or a frequency value calculated based on a time interval for each time interval corresponding to a sampling rate of the second operation data.

14. The operation data providing method according to claim 11, further comprising:
(d) step of determining an event occurrence period including a time point which exceeds the threshold if the second operation data exceeds the threshold; and
(e) step of providing first period operation data corresponding to the event occurrence period of the second operation data to the second user terminal.

15. The operation data providing method according to claim 14, further comprising:
(f) step of acquiring second period operation data by resampling data corresponding to remaining periods of the event occurrence period of the second operation data at a sampling rate lower than a sampling rate of the first period operation data; and
(g) step of providing the second period operation data to the second user terminal,
wherein the first period operation data and the second period operation data are subsequently displayed in order of measurement times such that time axis intervals between data samples have the same interval in the second user terminal.

16. The operation data providing method according to claim 15,
wherein in the step (a), second additional operation data is further acquired by resampling first additional operation data collected by an additional sensor assembly, and
wherein in the step (e), first period additional operation data corresponding to the event occurrence period of the second additional operation data is provided to the second user terminal, and the first period operation data and the first period additional operation data are displayed on the same time axis in the second user terminal.

17. An operation data providing method which is performed by a user terminal providing a user with operation data, comprising:
(a) step of acquiring first period operation data corresponding to an event occurrence period of operation data measured by a sensor assembly from a server;
(b) step of acquiring second period operation data obtained by resampling data corresponding a remaining period of the event occurrence period of the operation data at a sampling rate lower than a sampling rate of the first period operation data, from the server; and
(c) step of subsequently displaying the first period operation data and the second period operation data in order of measurement times such that time axis intervals between data samples are equal to each other,
wherein the event occurrence period is a period determined to include a time point exceeding a threshold when the server determines that the operation data exceeds the threshold.

18. The operation data providing method according to claim 17,
wherein in the step (a), first period additional operation data obtained by resampling partial additional operation data corresponding to the event occurrence period of additional operation data measured by an additional sensor assembly is acquired from the server, and
wherein in the step (c), the first period operation data and the first period additional operation data are displayed on the same time axis.
